(19) United States
(12) Patent Application Publication
(10) Pub. No.: US 2010/0018793 A1
(43) Pub. Date: Jan. 28, 2010

(54) SADDLE-TYPE VEHICLES HAVING DUAL L-SHAPED RADIATORS

(76) Inventor: David W. Arnold, Glendale, CA (US)

Correspondence Address: ULMER & BERNE, LLP;ATTN: DIANE BELL, 600 VINE STREET, SUITE 2800, CINCINNATI, OH, 45202, US

(21) Appl. No.: 12/178,879

(22) Filed: Jul. 24, 2008

(51) Int. Cl. B62M 7/00

(52) U.S. Cl. 180/229

(57) ABSTRACT

A saddle-type vehicle, such as a motorcycle, includes a frame, a left radiator, and a right radiator. The frame includes a steering interface and a forward member which are each intersected by an imaginary plane which bisects the saddle-type vehicle into left and right sides. The left radiator is supported by the frame and is disposed upon the left side of the saddle-type vehicle. The right radiator is supported by the frame, is spaced from the left radiator, and is disposed upon the right side of the saddle-type vehicle.

### TECHNICAL FIELD

A saddle-type vehicle, such as a motorcycle, includes dual L-shaped radiators disposed upon opposite sides of a forward frame member.

### BACKGROUND

A radiator is commonly provided upon a conventional saddle-type vehicle (e.g., a motorcycle) as part of an engine cooling system present upon the vehicle. However, as adequate cooling of the engine commonly requires the radiator to include a relatively large air receiving face, it can often be difficult to effectively incorporate a radiator into a vehicle without adding excessive bulk or weight to the vehicle, and/or without detracting from the vehicle's aesthetic styling.

### SUMMARY

In accordance with one embodiment, a motorcycle comprises a frame, a fork, an engine, a left radiator, and a right radiator. The frame comprises a head tube and a forward member. The head tube and the forward member are each intersected by an imaginary plane which bisects the motorcycle into left and right sides. The forward member has a rear surface, a left surface, and a right surface. The fork rotatably supports a front wheel and is attached to the head tube such that the fork is pivotable about a steering axis. The steering axis resides entirely within the imaginary plane. The engine has a forward wall, an upper wall, a left side wall, and a right side wall. The engine is supported by the frame such that the forward wall is adjacent to the rear surface of the forward member. The left radiator is supported by the frame such that respective vertically extending portions of a left inside edge of the left radiator are laterally offset with respect to one another and the imaginary plane and are respectively adjacent to the left surface of the forward member and the left side wall of the engine. The left radiator is disposed entirely upon the left side of the motorcycle. The right radiator is supported by the frame such that respective vertically extending portions of a right inside edge of the right radiator are laterally offset with respect to one another and the imaginary plane and are respectively adjacent to the right surface of the forward member and the right side wall of the engine. The right radiator is spaced from the left radiator and is disposed entirely upon the right side of the motorcycle.

In accordance with one embodiment, a saddle-type vehicle comprises a frame, a left radiator, and a right radiator. The frame comprises a steering interface and a forward member which are each intersected by an imaginary plane which bisects the saddle-type vehicle into left and right sides. The left radiator is supported by the frame and is disposed upon the left side of the saddle-type vehicle. The right radiator is supported by the frame, is spaced from the left radiator, and is disposed upon the right side of the saddle-type vehicle. Each of the left radiator and the right radiator comprises a respective L-shaped air receiving face extending perpendicularly to the imaginary plane.

### BRIEF DESCRIPTION OF THE DRAWINGS

It is believed that certain embodiments will be better understood from the following description taken in conjunction with the accompanying drawings in which:

FIG. 1 is a right side view depicting a motorcycle in accordance with one embodiment;

FIG. 2 is a front view generally depicting certain components of the motorcycle of FIG. 1, wherein other components of the motorcycle (e.g., the fork, the front wheel, and the handlebar) have been removed for clarity of illustration; and

FIG. 3 is a left side view generally depicting the components of FIG. 2.

### DETAILED DESCRIPTION

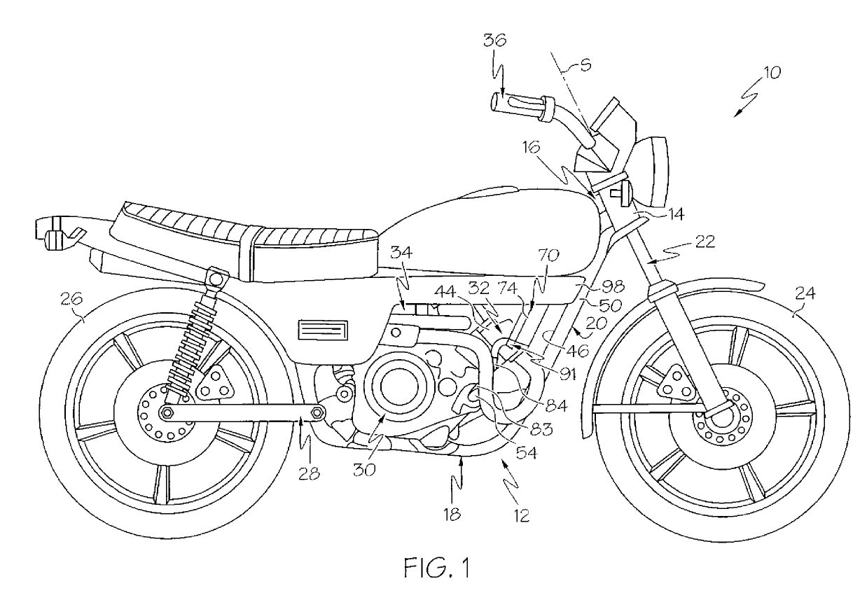

Embodiments are hereinafter described in detail in connection with the views and examples of FIGS. 1-3, wherein like numbers indicate the same or corresponding elements throughout the views. In accordance with one embodiment, a saddle-type vehicle can be provided with an engine and a cooling system. A saddle-type vehicle can comprise a motorcycle 10 as shown in FIG. 1, for example. However, in alternative embodiments, a saddle-type vehicle can comprise a personal watercraft (PWC), an all terrain vehicle (ATV), a scooter, a snowmobile, or the like.

The motorcycle 10 is shown in FIG. 1 to comprise a frame 12. The frame 12 is shown to include a steering interface (e.g., a head tube 14), an upper member 16, a lower member 18, and a forward member 20. The upper member 16 is shown to extend from its attachment to the head tube 14 and obliquely downwardly to its pivotal attachment to a swing arm 28. The forward member 20 is shown to extend generally vertically and downwardly from the upper member 16. The lower member 18 is shown to extend generally horizontally and rearwardly from the forward member 20 to a rearward end of the upper member 16. A fork 22 is shown to be rotatably attached to the head tube 14 such that the fork 22 is pivotal about a steering axis “S” under control of a handlebar 36 attached to the fork 22. The fork 22 is shown to rotatably support a front wheel 24, while the swing arm 28 is shown to pivotably support a rear wheel 26. While the steering interface is shown to comprise the head tube 14, it will be appreciated that a saddle-type vehicle can include a steering interface provided in any of a variety of other suitable arrangements.

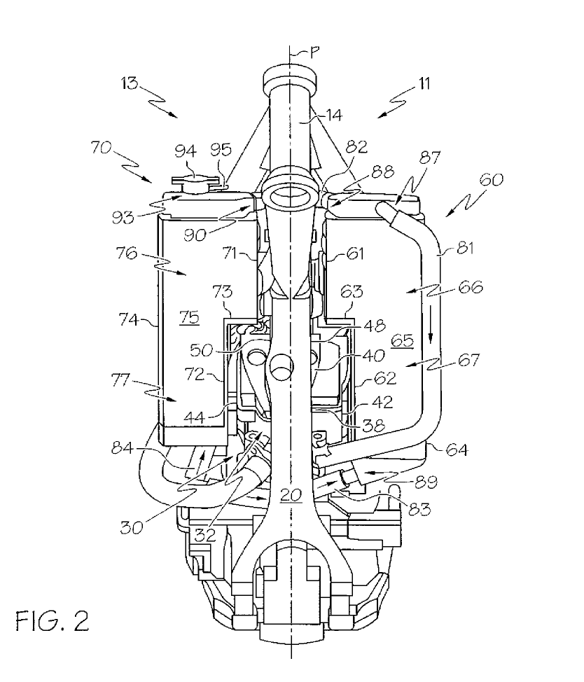

In one embodiment, as shown in FIGS. 1-3, the forward member 20 of the frame 12 can comprise a single forward member which is centrally located (as opposed to comprising two spaced and parallel forward members disposed upon opposite sides of an engine as is typical of certain conventional motorcycles). In this configuration, as shown in FIG. 2, it can be seen that an imaginary plane “P” which bisects the motorcycle 10 into left and right sides 11, 13 can also intersect the forward member 20. This same imaginary plane is also shown to intersect the head tube 14, and the steering axis S can reside entirely within the imaginary plane.

Portions of a vehicle's frame can provide a carriage for supporting an engine. For example, as shown in FIG. 1, the lower member 18 and the forward member 20 can be configured for supporting an engine 30 with respect to the remainder of the motorcycle 10. The engine 30 can be attached (e.g., with bolts) to one or both of the lower member 18 and the forward member 20. The engine 30 might also be attached (e.g., with bolts) to the upper member 16. It will be appreciated that an engine can be partially or entirely supported by one or more frame members of a saddle-type vehicle in any of a variety of other suitable configurations.

The engine 30 is shown in FIG. 1 to comprise a V-twin engine (i.e., having two pistons arranged, in a V-shape) having a forward cylinder housing 32 and a rearward cylinder housing 34. However, it will be appreciated that a saddle-type vehicle, such as a motorcycle, can include any of a variety of other types of engines such as a single-cylinder engine, a non-V-type multi-cylinder engine, a V-type multi-cylinder engine having more than two pistons, or an electric motor such as might be provided in a hybrid or other electric drive arrangement.

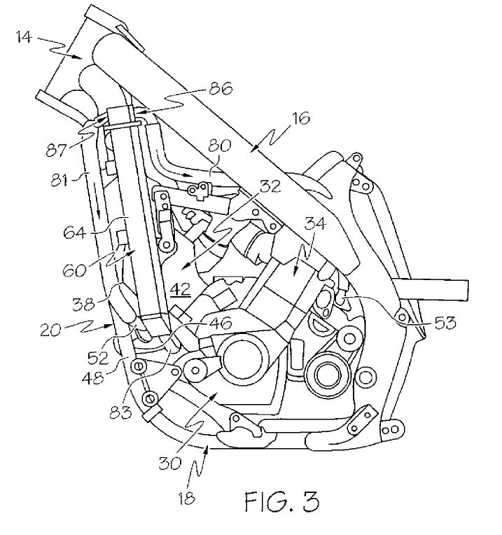

An engine can be supported by a frame of a saddle-type vehicle such that a forward wall of the engine is adjacent to a forward member of the frame. For example, in the embodiment of FIGS. 1-3, the forward cylinder housing 32 of the engine 30 is shown to comprise a forward wall 38. In one embodiment, the forward wall 38 can comprise the forward-most portion of the engine 30 upon the motorcycle 10. In such an embodiment, the engine 30 can be supported by the frame 12 such that the forward wall 38 is adjacent to a rear surface 46 of the forward member 20 of the frame 12, as best shown in FIG. 3.

The motorcycle 10 can provide a cooling system to facilitate cooling of the engine 30 during use of the motorcycle 10. In particular, the cooling system is shown to comprise left and right radiators 60 and 70. As described in further detail below, coolant fluid can be circulated through the engine 30, the left radiator 60, and the right radiator 70 during use of the motorcycle 10 to facilitate cooling of the engine 30.

The left radiator 60 is shown in FIGS. 2-3 to be supported by the frame 12 such that the left radiator 60 is disposed entirely upon the left side 11 of the motorcycle 10. In one embodiment, the left radiator 60 can be directly or indirectly attached to the frame 12 with bolts or other fasteners. In another embodiment, a left radiator can be attached to a frame through use of welding, adhesives, mechanically interlocking arrangements, and/or otherwise. Once the left radiator 60 is attached to the frame 12, a body panel (not shown, but may be similar to a body panel 98 shown in FIG. 1) can be provided to at least partially cover the left radiator 60 such as for enhancing aesthetics and/or aerodynamics of the motorcycle 10. The frame 12 and/or the left radiator 60 can include one or more tabs or other features which might facilitate attachment of such a body panel.

The left radiator 60 can comprise a left air receiving face 65 which can be configured to receive passing air during forward motion of the motorcycle 10. In another embodiment, an air receiving face of a left radiator can additionally or alternatively be configured to receive passing air from an electric fan associated with the left radiator. In one embodiment, as shown in FIG. 2, the left air receiving face 65 can be L-shaped and can comprise a left upper section 66 and a left lower section 67. The left air receiving face 65 is shown to extend perpendicularly to the imaginary plane P between a left inside edge of the left radiator 60 and a left outside edge 64 of the left radiator 60. The left outside edge 64 can be substantially straight along its entire length, as shown in FIG. 2. The left inside edge is shown to comprise vertically extending portions 61 and 62 as well as a horizontally extending portion 63. The vertically extending portions 61 and 62 are shown to be laterally offset with respect to one another and the imaginary plane P. The horizontally extending portion 63 is shown to extend between the respective vertically extending portions 61 and 62. In one embodiment, as shown in FIG. 2, the vertically extending portions 61, 62 can be parallel with the imaginary plane P, while the horizontally extending portion 63 can be perpendicular to the imaginary plane P.

The left upper section 66 of the left air receiving face 65 is shown to correspond with the vertically extending portion 61 of the left inside edge of the left radiator 60. The left lower section 67 of the left air receiving face 65 is shown to correspond with the vertically extending portion 62 of the left inside edge of the left radiator 60. In the embodiment of FIGS. 1-3, the left upper section 66 is shown to be wider than the left lower section 67.

The vertically extending portion 61 of the left inside edge of the left radiator 60 is shown to be adjacent to a left surface 48 of the forward member 20 of the frame 12. Likewise, the vertically extending portion 62 of the left inside edge of the left radiator 60 is shown to be adjacent to a left side wall 42 of the engine 30. The horizontally extending portion 63 of the left inside edge of the left radiator 60 is shown to be adjacent to an upper wall 40 of the engine 30. While the left side wall 42 and the upper wall 40 are both shown to be provided by a forward cylinder housing 32 of the engine 30, it will be appreciated that a left side wall and an upper wall can alternatively be provided by one or more other portions of an engine.

As shown in FIG. 2, the left radiator 60 and the right radiator 70 are shown to be adjacent to opposite sides of the forward member 20 of the frame 12. As also shown in FIG. 2, the left radiator 60 and the right radiator 70 can substantially mirror one another in a corresponding relationship upon opposite sides of the imaginary plane P and of the motorcycle 10. In particular, the right radiator 70 is shown in FIGS. 1-2 to be supported by the frame 12 such that the right radiator 70 is disposed entirely upon the right side 13 of the motorcycle 10. In one embodiment, the right radiator 70 can be directly or indirectly attached to the frame 12 with bolts or other fasteners. In another embodiment, a right radiator can be attached to a frame through use of welding, adhesives, mechanically interlocking arrangements, and/or otherwise. Once the right radiator 70 is attached to the frame 12, a body panel (e.g., 98 in FIG. 1) can be provided to at least partially cover the right radiator 70 such as for enhancing aesthetics and/or aerodynamics of the motorcycle 10. The frame 12 and/or the right radiator 70 can include one or more tabs or other features which might facilitate attachment of such a body panel.

The right radiator 70 can comprise a right air receiving face 75 which can be configured to receive passing air during forward motion of the motorcycle 10. In another embodiment, an air receiving face of a right radiator can additionally or alternatively be configured to receive passing air from an electric fan associated with the right radiator. In one embodiment, as shown in FIG. 2, the right air receiving face 75 can be L-shaped and can comprise a right upper section 76 and a right lower section 77. In one embodiment, as also shown in FIG. 2, the left air receiving face 65 and the right air receiving face 75 can have a substantially equal surface area. The right air receiving face 75 is shown to extend perpendicularly to the imaginary plane P between a right inside edge of the right radiator 70 and a right outside edge 74 of the right radiator 70. The right outside edge 74 can be substantially straight along its entire length, as shown in FIG. 2. The right inside edge is shown to comprise vertically extending portions 71 and 72 as well as a horizontally extending portion 73. The vertically extending portions 71 and 72 are shown to be laterally offset with respect to one another and the imaginary plane P. The horizontally extending portion 73 is shown to extend between the respective vertically extending portions 71 and 72. In one embodiment, as shown in FIG. 2, the vertically extending portions 71, 72 can be parallel with the imaginary plane P, while the horizontally extending portion 73 can be perpendicular to the imaginary plane P.

The right upper section 76 of the right air receiving face 75 is shown to correspond with the vertically extending portion 71 of the right inside edge of the right radiator 70. The right lower section 77 of the right air receiving face 75 is shown to correspond with the vertically extending portion 72 of the right inside edge of the right radiator 70. In the embodiment of FIGS. 1-3, the right upper section 76 is shown to be wider than the right lower section 77.

The vertically extending portion 71 of the right inside edge of the right radiator 70 is shown to be adjacent to a right surface 50 of the forward member 20 of the frame 12. Likewise, the vertically extending portion 72 of the right inside edge of the right radiator 70 is shown to be adjacent to a right side wall 44 of the engine 30. The horizontally extending portion 73 of the right inside edge of the right radiator 70 is shown to be adjacent to the upper wall 40 of the engine 30. While the right side wall 44 is shown to be provided by a forward cylinder housing 32 of the engine 30, it will be appreciated that a right side wall can alternatively be provided by one or more other portions of an engine.

By providing left and right radiators in an L-shape (e.g., as shown in FIG. 2), it will be appreciated that many advantages can be achieved. First, such a configuration can accommodate passage of a vertically extending frame member (e.g., forward member 20), as well as a portion of an engine, between the radiators. As another example, such L-shaped radiators can have sufficiently large air receiving faces (e.g., 65, 75) to facilitate effective cooling of an engine, but without requiring an associated vehicle (e.g., motorcycle 10) to have an excessive overall width, and without requiring any portion of the radiators (e.g., 60, 70) to become so close to the ground as to risk damage, adversely affect aesthetics of the vehicle, and/or interfere with other structures of the vehicle.

A cooling system can also include one or more conduits to facilitate passage of coolant fluid among an engine and radiators. For example, multiple conduits (e.g., hoses) can be provided to connect the left and right radiators 60, 70 with the engine 30 and each other. These conduits can be configured to transmit coolant fluid (e.g., water, ethylene, glycol, diethylene glycol, and/or propylene glycol) among the engine 30 and the left and right radiators 60, 70. It will be appreciated that such conduits can comprises hoses, rigid tubing, or any of a variety of other suitable structures.

An engine can include multiple inlets to facilitate passage of coolant fluid to and from the engine for cooling of the engine. For example, with reference to FIGS. 1-3, the engine 30 is shown to comprise a main inlet 54. In addition, the forward cylinder housing 32 of the engine 30 can comprise a forward inlet 52, and the rearward cylinder housing 34 of the engine 30 can comprise a rearward inlet 53. As described in further detail below, the main inlet 54, the forward inlet 52, and the rearward inlet 53 can be provided in fluid communication with each of the left and right radiators 60, 70.

The left radiator 60 is shown to comprise left top ports 86, 87, and 88 and a left bottom port 89. The right radiator 70 is shown to comprise a right top port 90 and a right bottom port 91. A first conduit 80 is shown in FIG. 3 to be attached to the left top port 86 of the left radiator 60 and to rearward inlet 53 of the engine 30. A second conduit 81 is shown in FIG. 3 to be attached to the left top port 87 of the left radiator 60 and to forward inlet 52 of the engine 30. A third conduit 82 is shown in FIG. 2 to be attached to each of the left top port 88 of the left radiator 60 and the right top port 90 of the right radiator 70. Referring to FIGS. 1-3, a fourth conduit 83 is shown to be attached to the left bottom port 89 of the left radiator 60 and to the main inlet 54 of the engine 30. A fifth conduit 84 is shown in FIGS. 1-2 to be attached to the right bottom port 91 of the right radiator 70 and to the main inlet 54 of the engine 30. In one embodiment, each of the first conduit 80, the second conduit 81, the third conduit 82, the fourth conduit 83, and the fifth conduit 84 comprise respective rubber hoses.

In this arrangement, the first conduit 80 facilitates the flow of coolant fluid between the left radiator 60 and the rearward inlet 53 of the engine 30. The second conduit 81 facilitates the flow of coolant fluid between the left radiator 60 and the forward inlet 52 of the engine 30. The third conduit 82 facilitates the flow of coolant fluid between the left radiator 60 and the right radiator 70. The fourth conduit 83 facilitates the flow of coolant fluid between the left radiator 60 and the main inlet 54 of the engine 30. The fifth conduit 84 facilitates the flow of coolant fluid between the right radiator 70 and the main inlet 54 of the engine 30.

For example, in one embodiment, as shown by flow arrows in FIGS. 1-3, coolant fluid can flow in a direction from the main inlet 54, through each of the fourth and fifth conduits 83, 84, and into each of the left and right radiators 60, 70. In one embodiment, a wye fitting can be provided to attach the main inlet 54 to each of the fourth and fifth conduits 83, 84. During operation, a portion (e.g., approximately half) of the coolant fluid exiting the main inlet 54 of the engine 30 can pass to and through the left radiator 60, while the remaining coolant fluid exiting the main inlet 54 passes to and through the right radiator 70. Coolant fluid is shown to exit the right radiator 70 and to pass through the third conduit 82 and into the left radiator 60. The coolant fluid can then flow from the left radiator 60 and through the respective first and second conduits 80, 81, into the respective rearward and forward inlets. 53, 52 of the rearward and forward cylinder housings 34, 32 of the engine 30 (e.g., with roughly half of the coolant fluid being passed to each respective cylinder housing). After passing within the engine 30, the coolant fluid can again be expelled from the main inlet 54, through each of the fourth and fifth conduits 83, 84, and into each of the left and right radiators 60, 70.

In this configuration, it can be seen that coolant fluid which has been heated by the engine 30 can be divided before being passed into the respective left and right radiators 60, 70. By dividing the heated coolant fluid in this manner, it will be appreciated that neither of the left nor right radiators 60, 70 is likely to be subjected to hotter coolant fluid than is the other of the radiators, thereby helping to ensure that the useful lives of both of the radiators is approximately equivalent. Also, by passing cooled coolant fluid from a common location at the top of a single radiator (e.g., the left radiator 60), it will be appreciated that similarly cooled coolant fluid can be provided to each of the forward and rearward cylinder housings 32, 34 of the engine 30.

It will be appreciated that this arrangement provides redundancy and can accordingly facilitate increased reliability of a cooling system. For example, if a blockage occurs in the left radiator 60, all coolant fluid from the main inlet 54 of the engine 30 can automatically be passed through the fifth conduit 84, into the right radiator 70, through the third conduit 82, and from the top of the left radiator 60 to the respective forward and rearward cylinder housings 32, 34 of the engine 30. Likewise, if a blockage occurs in the right radiator 70, all coolant fluid from the main inlet 54 of the engine 30 can automatically be passed through the fourth conduit 83, into the left radiator 60, and from the top of the left radiator 60 to the respective forward and rearward cylinder housings 32, 34 of the engine 30. Such redundancy can facilitate continued use of the motorcycle 10 for at least some period of time upon blockage of the left radiator 60 or the right radiator 70. This period of time might be sufficient such that an operator can drive the motorcycle to a service establishment, and might thereby prevent the operator from becoming stranded. It will be appreciated, however, that coolant fluid can flow through the cooling system of FIGS. 1-3 in an opposite direction or in some other arrangement. It will also be appreciated that ports can be provided in an engine and radiators in any of a variety of alternative configurations, and that conduits can be provided in any of a variety of other suitable arrangements for facilitating communication of coolant fluid among an engine and radiators.

It will be appreciated that a pump (often called a coolant pump or water pump) can be provided to facilitate pressurized movement of coolant fluid through a coolant system. In one embodiment, the pump might be internal to an engine. In another embodiment, the pump might be bolted to the side of an engine, such as near an engine's main inlet.

The right radiator 70 is shown to comprise a fill port 93. A cap 94 can be selectively attached to the fill port 93. The cap 94 can be removed to facilitate filling of the cooling system by an operator through use of the fill port 93. During operation of the engine 30, it will be appreciated that the cap 94 can be secured in place (e.g., threaded) upon the fill port 93. The right radiator 70 is also shown to include a reservoir port 95 which can be configured for connection via a conduit to a remote coolant fluid reservoir (not shown). In another embodiment, a left radiator might additionally or alternatively be provided with a fill port and/or a reservoir port.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the Claims appended hereto.

1. A motorcycle comprising:
a frame comprising a head tube and a forward member, the head tube and the forward member each being intersected by an imaginary plane which bisects the motorcycle into left and right sides, the forward member having a rear surface, a left surface, and a right surface;
a fork rotatably supporting a front wheel and attached to the head tube such that the fork is pivotable about a steering axis, the steering axis residing entirely within the imaginary plane;
an engine having a forward wall, an upper wall, a left side wall, and a right side wall, the engine supported by the frame such that the forward wall is adjacent to the rear surface of the forward member;
a left radiator supported by the frame such that respective vertically extending portions of a left inside edge of the left radiator are laterally offset with respect to one another and the imaginary plane and are respectively adjacent to the left surface of the forward member and the left side wall of the engine, wherein the left radiator is disposed entirely upon the left side of the motorcycle; and
a right radiator supported by the frame such that respective vertically extending portions of a right inside edge of the right radiator are laterally offset with respect to one another and the imaginary plane and are respectively adjacent to the right surface of the forward member and the right side wall of the engine, wherein the right radiator is spaced from the left radiator and is disposed entirely upon the right side of the motorcycle.

2. The motorcycle of claim 1 wherein the left radiator comprises a left air receiving face extending perpendicularly to the imaginary plane between the left inside edge and a left outside edge, the right radiator comprises a right air receiving face extending perpendicularly to the imaginary plane between the right inside edge and a right outside edge, and each of the left air receiving face and the right air receiving face is L-shaped.

3. The motorcycle of claim 2 wherein the left air receiving face comprises a left upper section and a left lower section, the left upper section corresponds with the vertically extending portion of the left inside edge which is adjacent to the left surface of the forward member, the left lower section corresponds with the vertically extending portion of the left inside edge which is adjacent to the left side wall of the engine, the left outside edge is substantially straight, the left upper section is wider than the left lower section, the right air receiving face comprises a right upper section and a right lower section, the right upper section corresponds with the vertically extending portion of the right inside edge which is adjacent to the right surface of the forward member, the right lower section corresponds with the vertically extending portion of the right inside edge which is adjacent to the right side wall of the engine, the right outside edge is substantially straight, and the right upper section is wider than the right lower section.

4. The motorcycle of claim 3 wherein each of the left air receiving face and the right air receiving face is configured to receive passing air during forward motion of the motorcycle.

5. The motorcycle of claim 4 wherein the left air receiving face and the right air receiving face have a substantially equal surface area.

6. The motorcycle of claim 5 wherein the left radiator and the right radiator substantially mirror one another in a corresponding relationship upon opposite sides of the imaginary plane.

7. The motorcycle of claim 6 wherein the engine comprises a cylinder housing which defines each of the forward wall, the upper wall, the left side wall, and the right side wall.

8. The motorcycle of claim 7 wherein the engine comprises a V-twin engine and the cylinder housing comprises a forward cylinder housing of the V-twin engine.

9. The motorcycle of claim 1 wherein the engine comprises a forward cylinder housing, a rearward cylinder housing and a main inlet, the forward cylinder housing comprises a forward inlet, the rearward cylinder housing comprises a rearward inlet, and the main inlet, the forward inlet, and the rearward inlet are provided in fluid communication with each of the left radiator and the right radiator.

10. The motorcycle of claim 9 further comprising a first conduit, a second conduit, a third conduit, a fourth conduit, and a fifth conduit, wherein the first conduit facilitates fluid flow between the left radiator and the rearward inlet, the second conduit facilitates fluid flow between the left radiator and the forward inlet, the third conduit facilitates fluid flow between the left radiator and the right radiator, the fourth conduit facilitates fluid flow between the left radiator and the main inlet, and the fifth conduit facilitates fluid flow between the right radiator and the main inlet.

11. The motorcycle of claim 10 wherein the left radiator comprises a first left top port, a second left top port, a third left top port, and a left bottom port, the right radiator comprises a right top port and a right bottom port, the first conduit is attached to the first left top port, the second conduit is attached to the second left top port, the third conduit is attached to the third left top port and the right top port, the fourth conduit is attached to the left bottom port, and the fifth conduit is attached to the right bottom port.

12. The motorcycle of claim 10 being configured such that fluid flows in a direction from the main inlet, through each of the fourth conduit and the fifth conduit, and into each of the left radiator and the right radiator.

13. The motorcycle of claim 10 wherein the first conduit, the second conduit, the third conduit, the fourth conduit, and the fifth conduit comprise respective rubber hoses.

14. The motorcycle of claim 1 further comprising a handlebar attached to the fork.

15. The motorcycle of claim 1 wherein a horizontally extending portion of the left inside edge of the left radiator extends between the respective vertically extending portions of the left inside edge of the left radiator and is adjacent to the upper wall of the engine, and wherein a horizontally extending portion of the right inside edge of the right radiator extends between the respective vertically extending portions of the right inside edge of the right radiator and is adjacent to the upper wall of the engine.

16. The motorcycle of claim 15 wherein each of the respective vertically extending portions of the left inside edge of the left radiator is parallel with the imaginary plane, the horizontally extending portion of the left inside edge of the left radiator is perpendicular to the imaginary plane, each of the respective vertically extending portions of the right inside edge of the right radiator is parallel with the imaginary plane, and the horizontally extending portion of the right inside edge of the right radiator is perpendicular to the imaginary plane.

17. A saddle-type vehicle comprising:
a frame comprising a steering interface and a forward member each being intersected by an imaginary plane which bisects the saddle-type vehicle into left and right sides;
a left radiator supported by the frame and disposed upon the left side of the saddle-type vehicle; and
a right radiator supported by the frame, spaced from the left radiator, and disposed upon the right side of the saddle-type vehicle;
wherein each of the left radiator and the right radiator comprises a respective L-shaped air receiving face extending perpendicularly to the imaginary plane; and
wherein the left radiator and the right radiator are adjacent to opposite sides of the forward member of the frame.

18. The saddle-type vehicle of claim 17 comprising a motorcycle.

19. The saddle-type vehicle of claim 18 wherein the steering interface comprises a head tube.

20. The saddle-type vehicle of claim 19 further comprising a fork and a handlebar attached to the fork, wherein the fork is rotatably attached to the head tube such that the fork is pivotable about a steering axis residing entirely within the imaginary plane.

21. (canceled)

22. The saddle-type vehicle of claim 17 further comprising an engine supported by the frame and having respective walls adjacent to each of the left radiator, the right radiator, and the forward member of the frame.

23. A saddle-type vehicle comprising:
a frame comprising a steering interface and a forward member each being intersected by an imaginary plane which bisects the saddle-type vehicle into left and right sides;
an engine supported by the frame;
a left radiator supported by the frame and disposed upon the left side of the saddle-type vehicle;
a right radiator supported by the frame, spaced from the left radiator, and disposed upon the right side of the saddle-type vehicle; and
a first conduit, a second conduit and a third conduit; wherein
the engine comprises a first cylinder housing and a second cylinder housing, the first cylinder housing comprising a first inlet, the second cylinder housing comprising a second inlet; and
the first conduit establishes fluid communication between the left radiator and the second inlet, the second conduit establishes fluid communication between the left radiator and the first inlet, and the third conduit is attached to the left radiator and the right radiator and establishes fluid communication between the left radiator and the right radiator.

24. The saddle-type vehicle of claim 23, wherein:
the left radiator is disposed entirely upon the left side of the saddle-type vehicle; and
the right radiator is disposed entirely upon the right side of the saddle-type vehicle.

25. The saddle-type vehicle of claim 23, wherein:
the first cylinder housing is a forward cylinder housing and the second cylinder housing is a rearward cylinder housing; and
the first inlet is a forward inlet and the second inlet is a rearward inlet.
